(19) United States
(12) Patent Application Publication
(10) Pub. No.: US 2024/0372135 A1
(43) Pub. Date: Nov. 7, 2024

(54) ION CONDUCTIVE COMPOSITE MATERIAL

(71) Applicant: TOYOTA MOTOR ENGINEERING & MANUFACTURING NORTH AMERICA, INC., Plano, TX (US)

(72) Inventors: Shingo OTA, Ann Arbor, MI (US); Nikhilendra SINGH, Ann Arbor, MI (US)

(73) Assignee: TOYOTA MOTOR ENGINEERING & MANUFACTURING NORTH AMERICA, INC., Plano, TX (US)

(21) Appl. No.: 18/310,676

(22) Filed: May 2, 2023

(51) Int. Cl. H01M 10/0562; H01M 4/1315; H01M 4/36; H01M 4/525; H01M 10/0525; H01M 10/056

(52) U.S. Cl. CPC H01M 10/0562; H01M 4/1315; H01M 4/364; H01M 4/525; H01M 10/0525; H01M 10/056; H01M 2300/008; H01M 2300/0091

(57) ABSTRACT

A metal ion conductive composition containing an intimate mixture of particles of Fe₍₁₋ₐ₎MₐO_{(1-z)}Y_{z}X and a metal ion salt is provided. In the formula M is a cation, Y is an anion selected from the group consisting of N, S and Se, X is at least one halide selected from the group consisting of F, Cl, Br and I, a is a number from 0 to 0.75 and z is a number from 0 to 0.75 The particle size of the Fe₍₁₋ₐ₎MₐO_{(1-z)}Y_{z}X particles is 500 nm or less and the metal ion salt contains a metal ion selected from alkali metals, alkaline earth metals, Zinc ion and Aluminum ion. A solid-state metal ion battery containing the metal ion conductive composition is described and in one embodiment, a solid-state lithium-ion battery containing the metal ion conductive composition is disclosed.

### FIELD OF DISCLOSURE

This disclosure is directed to a novel composite material exhibiting high metal ion conductivity which is useful as an electrolyte component of electrodes and/or solid electrolytes of solid-state metal-ion batteries. In one embodiment this disclosure is directed to a novel composite material exhibiting high lithium-ion conductivity which is useful as an electrolyte component of solid-state lithium-ion batteries.

### BACKGROUND

Li-ion batteries have traditionally dominated the market of portable electronic devices. However, conventional Li-ion batteries contain flammable organic solvents as components of the electrolyte and this flammability is the basis of a safety risk which is of concern and could limit or prevent the use of Li-ion batteries for application in large scale energy storage.

Replacing the flammable organic liquid electrolyte with a solid Li-conductive phase alleviates this safety issue and may provide additional advantages such as improved mechanical and thermal stability. Moreover, lithium batteries constructed with nonaqueous electrolytes are known to form dendritic lithium metal structures projecting from the anode to the cathode over repeated discharge and charge cycles. When such a dendrite structure projects to the cathode, the dendrite short circuits the battery and energy is rapidly released which can initiate ignition of the organic solvent.

Therefore, much research and development effort directed to batteries which employ solid metal conductive electrolyte materials which do not contain flammable solvents is ongoing.

A primary function of the solid metal ion conductive phase, usually called solid metal-ion conductor or solid-state electrolyte, is to conduct metal ions from the anode side to the cathode side during discharge and from the cathode side to the anode side during charge while blocking the direct transport of electrons between electrodes within the battery.

Moreover, to provide batteries for large scale energy storage an increase in the practical energy density is required. The Li-metal battery and all-solid-state batteries offer potential advancement in the increase of energy density. With the extra-high capacity (3860 mAh g−1) and the lowest negative electrochemical potential, Li metal is the ideal anode candidate to offer the promise of high energy density. The Li metal batteries (LMBs), including Li-sulfur (Li—S) batteries, Li-oxygen (Li—O₂) batteries, Li anode vs intercalation type cathode batteries, etc., have the potential to provide a huge increase in theoretical energy density relative to the current LIBs.

Li-ion batteries provide a combination of high energy and power density suitable for use in hybrid/all-electric vehicles, power tools, and other portable electronic applications. Li-ion batteries can also be used in various power grid applications because of their high energy efficiency.

However, lithium has a very low abundance in the earth's crust and therefore, as utility increases, the availability will decrease leading to cost increase and an adverse effect on the economic viability of lithium batteries.

Therefore, next-generation battery systems based upon other metals of greater availability including sodium, potassium, magnesium, calcium, zinc and aluminum are of great interest. For example, magnesium-ion batteries (MIBs) and aluminum-ion batteries (AIBs) have potential as alternatives to lithium-ion batteries (LIBs) because of their safety, low cost & environment friendliness. Magnesium does not tend to form dendrites and a magnesium-ion battery can last substantially longer than a lithium-ion battery. Magnesium is reported to be the second most abundant element on the earth's crust, eliminating the depletion risk, and granting a much cheaper product.

However, development of a next generation of solid-state lithium ion batteries as well as future generation of alternative metal ion batteries requires the development of electrolytic materials which function as solid-state electrolytes and/or electrolyte components of electrode active materials.

Such electrolyte materials must provide many important properties, including
(1) High metal ion conductivity;
(2) Chemical and electrochemical stability when contacting anodic metals (Li in the case of a lithium-ion battery);
(3) Mechanical strength to prevent metal dendrite penetration.
(4) Elasticity to be efficiently processable in battery production and provide high density battery construction.

Accordingly, an object of this application is to provide a composite material having a high metal ion conductivity and other advantageous properties as listed above suitable for use as an electrolytic material as a solid-state electrolyte for a metal ion battery and/or an electrode active material component for a metal ion battery.

A further object of this application is to provide a solid-state metal ion battery and/or a solid-state metal ion battery containing these materials.

A specific object of this application is to provide a composite material having a high Li⁺ ion conductivity and other advantageous properties as listed above suitable for use as an electrolytic material as a solid-state electrolyte for a Li⁺ ion battery and/or an electrode active material component for a Li⁺ ion battery.

A further object of this application is to provide a solid-state lithium-ion battery containing these materials.

### SUMMARY OF THE EMBODIMENTS

These and other objects are provided by the embodiments of the present disclosure, the first embodiment of which includes a metal ion conductive composition, comprising:
an intimate mixture of at least one metal ion salt; and
a plurality of particles of Fe₍₁₋ₐ₎MₐO_{(1-z)}Y_{z}X;
wherein
M is a cation,
Y is an anion selected from the group consisting of N, S and Se,
X is at least one halide selected from the group consisting of F, Cl, Br and I,
a is a number from 0 to 0.75,
z is a number from 0 to 0.75,
the metal ion is selected from the group consisting of an alkali metal ion, an alkaline earth metal ion, Zn ion and Al ion, and
a particle size of the Fe₍₁₋ₐ₎MₐO_{(1-z)}Y_{z}X particles is 500 nm or less.

In one aspect of the first embodiment the anion component of the metal ion salt is selected from the group consisting of F⁻, Cl⁻, Br⁻, I⁻, ClO₄⁻, BF₆⁻ and PF₆⁻.

In one aspect of the first embodiment the metal ion conductive composition further comprises a ceramic electrolyte component or a polymer electrolyte component.

In one aspect of the first embodiment a mole ratio of the metal ion salt to the Fe₍₁₋ₐ₎Mₐ O_{(1-z)}Y_{z}X in the metal ion conductive composition is from 1/10 to 1/1.

In one aspect of the first embodiment M is selected from the group consisting of H, Mg, Ca, Al, Ga In, Se, Y, La, Ti, Zr, Hf, V, Nb, Ta, Cr, Mo and W.

In an aspect of the first embodiment, a is 0, z is 0 or a and z are 0. Further, in any of these aspects, X may be Cl.

In one aspect of the first embodiment the metal ion conductive composition comprises a ceramic electrolyte which is at least one ceramic electrolyte selected from the group consisting of a [symbol] -LiPO₄ oxy salt, a NASCION phosphate, a perovskite oxide and a garnet oxide and a content of the intimate mixture of a metal ion salt and a plurality of particles of FeOX is 30% by volume or more of the metal ion conductive composition.

In one aspect of the first embodiment the metal ion conductive composition comprises a polymer electrolyte which is at least one selected from the group consisting of a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS) and a content of the intimate mixture of a metal ion salt and a plurality of particles of FeOX is 1% by volume or more of the metal ion conductive composition.

In a further aspect of the first embodiment the metal ion conductive composition further comprises up to 15 wt % of a solvent selected from the group consisting of acetone, methanol, ethanol, propanol, methyl ethyl ketone and water.

In a second embodiment, the present disclosure provides a solid-state metal ion battery, comprising:
an anode comprising an anode active material capable of insertion and extraction of at least one of an alkali metal ion, an alkaline earth metal ion, Zn ion and Al ion;
a cathode comprising a cathode active material capable of insertion and extraction of the at least one of an alkali metal ion, an alkaline earth metal ion, Zn ion and Al ion; and
a solid-state electrolyte between the anode and cathode which is conductive of the at least one of an alkali metal ion, an alkaline earth metal ion, Zn ion and Al ion; wherein
at least one of the anode active material, cathode active material and solid-state electrolyte comprises the composition of the first embodiment.

In one aspect of the second embodiment the anode active material comprises at least one selected from the group consisting of an alkali metal, an alloy of an alkali metal, an alkaline earth metal, an alloy of an alkaline earth metal, zinc metal, a zinc alloy, aluminum metal, an aluminum alloy, graphite, hard carbon, lithium titanate (LTO), a tin/cobalt alloy, silicon, indium, bismuth and a silicon/carbon composite.

In one aspect of the second embodiment the cathode active material comprises at least one selected from the group consisting of LiCoO₂, V₂O₅, CoSiO₄MoO₃, CoSiO₄, sulfur, Mo₆S, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

In one aspect of the second embodiment the solid-state electrolyte comprises or consists of the intimate mixture of a metal ion salt and a plurality of particles of Fe₍₁₋ₐ₎MₐO_{(1-z)}Y_{z}X.

In one aspect of the second embodiment the solid-state electrolyte further comprises a ceramic electrolyte or a polymer electrolyte.

In one aspect of the second embodiment the ratio of the metal ion salt to the Fe₍₁₋ₐ₎Mₐ O_{(1-z)}Y_{z}X is from 1/10 to 1/1.

In one aspect of the second embodiment the solid state electrolyte comprises the intimate mixture of a metal ion salt and a plurality of particles of Fe₍₁₋ₐ₎MₐO_{(1-z)}Y_{z}X and further comprises a ceramic electrolyte which is at least one ceramic electrolyte selected from the group consisting of a x-LiPO₄ oxy salt, a NASCION phosphate, a perovskite oxide and a garnet oxide and a content of the intimate mixture of a metal ion salt and a plurality of particles of Fe₍₁₋ₐ₎Mₐ O_{(1-z)}Y_{z}X is 30% by volume or more of the solid state electrolyte.

In one aspect of the second embodiment the solid-state electrolyte comprises the intimate mixture of a metal ion salt and a plurality of particles of Fe₍₁₋ₐ₎MₐO_{(1-z)}Y_{z}X and further comprises a polymer electrolyte which is at least one selected from the group consisting of a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS) and a content of the intimate mixture of a metal ion salt and a plurality of particles of FeOCl is 1% by volume or more of the solid state electrolyte.

In one aspect of the second embodiment the anode active material comprises the intimate mixture of a metal ion salt; and a plurality of particles of Fe₍₁₋ₐ₎MₐO_{(1-z)}Y_{z}X and a content of the intimate mixture is from 0.1% to 50% by volume.

In one aspect of the second embodiment the cathode active material comprises the intimate mixture of a metal ion salt; and a plurality of particles of Fe₍₁₋ₐ₎Mₐ O_{(1-z)}Y_{z}X and a content of the intimate mixture is from 0.1% to 50% by volume.

In a third embodiment the present disclosure provides a solid-state lithium-ion battery, comprising:
an anode active material capable of insertion and extraction of Li⁺ ions;
a cathode active material capable of insertion and extraction of Li⁺ ions; and
a solid-state electrolyte between the anode and cathode which is conductive of Li⁺ ions;
wherein
at least one of the anode active material, cathode active material and solid-state electrolyte comprises the composition of the first embodiment, and
wherein the metal ion salt is a lithium salt selected from the group consisting of LiF, LiCl, LiBr, LiI, LiClO₄, LiBF₆ and LiPF₆.

In one aspect of the third embodiment, a is 0, z is 0 or a and z are 0. Further, in any of these aspects, X may be Cl.

In one aspect of third embodiment the anode active material comprises at least one selected from the group consisting of lithium metal, a lithium alloy graphite, hard carbon, lithium titanate (LTO), a tin/cobalt alloy, silicon, indium, bismuth and a silicon/carbon composite.

In one aspect of third embodiment the cathode active material comprises an active material selected from the group consisting of lithium cobalt oxide (LiCoO₂), lithium manganese oxide (LiMn₂O₄), lithium iron phosphate (LiFePO₄), lithium nickel manganese cobalt oxide (NMC), elemental sulfur and a metal sulfide composite.

In one aspect of third embodiment a mole ratio of the lithium salt to the Fe₍₁₋ₐ₎Mₐ O_{(1-z)}Y_{z}X is from 1/10 to 1/1.

In one aspect of third embodiment the solid-state electrolyte consists of or comprises the intimate mixture of a lithium-ion salt and a plurality of particles of Fe₍₁₋ₐ₎MₐO_{(1-z)}Y_{z}X.

In one aspect of third embodiment the solid state electrolyte comprises the intimate mixture of a lithium ion salt and a plurality of particles of Fe₍₁₋ₐ₎MₐO_{(1-z)}Y_{z}X and further comprises at least one of a ceramic material selected from the group consisting of [symbol] -LiPO₄ oxy salt, Li_{3.3}PO_{3.9}N_{0.17} (LiPON), Li₁₀GeP₂S₁₂ (LGPS), Li_{9.54}Si_{1.74}P_{1.44}Si_{11.7}Cl_{0.3}, Li₇La₃Zr₂O₁₂ (LLZO), halide doped lithium thiophosphates (Li₆PS₅X, X being Cl, Br or I), Li₁OSnP₂S₁₂ (LSPS), NASCION phosphate, a perovskite oxide and a garnet oxide and a content of the intimate mixture of a lithium ion salt and a plurality of particles of Fe₍₁₋ₐ₎MₐO_{(1-z)}Y_{z}X is 30% by volume or more of the solid state electrolyte.

In one aspect of third embodiment the solid state electrolyte comprises the intimate mixture of a lithium ion salt and a plurality of particles of Fe₍₁₋ₐ₎MₐO_{(1-z)}Y_{z}X and further comprises a polymer which is at least one selected from the group consisting of a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS) and a content of the intimate mixture of a lithium ion salt and a plurality of particles of Fe₍₁₋ₐ₎MₐO_{(1-z)}Y_{z}X is 1% by volume or more of the solid state electrolyte.

In one aspect of third embodiment the anode active material comprises the intimate mixture of a lithium-ion salt and a plurality of particles of Fe₍₁₋ₐ₎MₐO_{(1-z)}Y_{z}X and a content of the intimate mixture is from 0.1% to 50% by volume.

In one aspect of third embodiment the cathode active material comprises the intimate mixture of a lithium-ion salt; and a plurality of particles of Fe₍₁₋ₐ₎MₐO_{(1-z)}Y_{z}X and a content of the intimate mixture is from 0.1% to 50% by volume.

In one aspect of third embodiment the intimate mixture of a lithium-ion salt and a plurality of particles of Fe₍₁₋ₐ₎MₐO_{(1-z)}Y_{z}X further comprises up to 15 wt % of a solvent selected from the group consisting of acetone, methanol, ethanol, propanol, methyl ethyl ketone and water.

The foregoing description is intended to provide a general introduction and summary of the present disclosure and is not intended to be limiting in its disclosure unless otherwise explicitly stated. The presently preferred embodiments, together with further advantages, will be best understood by reference to the following detailed description taken in conjunction with the accompanying drawings.

### BRIEF DESCRIPTION OF THE DRAWINGS

FIG. 1 shows the relationship of Fe₍₁₋ₐ₎MₐO_{(1-z)}Y_{z}X (catalyst) particle size and metal ion conductivity for embodiments of the present disclosure.

FIG. 2 shows a schematic concept of the effect of Fe₍₁₋ₐ₎MₐO_{(1-z)}Y_{z}X (catalyst) particle size, and the nature and content of metal ion pathways formed in the electrolyte composite of the disclosure.

FIG. 3 shows the relationship of metal salt content in a composite of one aspect of this disclosure and metal ion conductivity.

FIG. 4 schematically shows one method to prepare an intimate mixture of FeOCl and LiCl according to one embodiment of the disclosure.

FIG. 5 schematically shows one method to prepare an intimate mixture of FeOCl and LiCl according to one embodiment of the disclosure.

FIG. 6 schematically shows one method to prepare an intimate mixture of FeOCl and LiCl according to one embodiment of the disclosure.

### DESCRIPTION OF THE PREFERRED EMBODIMENTS

Throughout this description, the terms “electrochemical cell” and “battery” may be employed interchangeably unless the context of the description clearly distinguishes an electrochemical cell from a battery. Further the terms “solid-state electrolyte” and “solid-state ion conductor” may be employed interchangeably unless explicitly specified differently. The description “metal ion conductive composition” refers explicitly to the intimate mixture of a metal ion salt; and plurality of particles of Fe₍₁₋ₐ₎MₐO_{(1-z)}Y_{z}X as disclosed herein. The identity of the metal ion salt, M, Y, a, z and X is determined by the embodiment of the present disclosure being discussed.

To qualify as solid-state electrolyte or electrode active material component in practical applications, a metal ion conductive material must meet several certain criteria. First, it should exhibit desirable metal-ion conductivity, usually no less than 10⁻⁶ S/cm at room temperature. Second, the material should have good stability against chemical, electrochemical and thermal degradation. Third, the material should have elasticity such that during battery preparation minimum pressure is required to form the component layers having a high density. Fourth, the synthesis of the material should be conducive to industrial scale production and the cost should be relatively low in comparison to conventionally known materials.

In ongoing studies of potential electrolytic materials, the present inventors have discovered that a novel intimate mixture of iron oxyhalides as described in the following paragraphs and a metal ion salt meets the requirements to function as a solid metal ion electrolyte listed above, especially a lithium-ion electrolyte, and thus, provide the present disclosure.

Accordingly, the first embodiment of the present disclosure provides a metal ion conductive composition, comprising an intimate mixture of a metal ion salt and a plurality of particles of Fe₍₁₋ₐ₎MₐO_{(1-z)}Y_{z}X; wherein the metal ion is selected from the group consisting of an alkali metal ion, an alkaline earth metal ion, Zn ion and Al ion, M is a cation, Y is an anion selected from the group consisting of N, S and Se, X is at least one halide selected from the group consisting of F, Cl, Br and I, a is a number from 0 to 0.75, z is a number from 0 to 0.75 and a particle size of the Fe₍₁₋ₐ₎MₐO_{(1-z)}Y_{z}X particles is 500 nm or less.

Iron oxyhalides may be obtained by heat treatment of a mixture containing an iron oxide, an iron halide, sources of dopants M and Y when included and water at temperatures from 100° C. to 400° C. or by thermal decomposition of mixtures of FeX₃·6H₂O and sources of dopants M and Y when included at temperatures greater than 200° C. The iron oxide may be any of FeO, Fe₂O₃ and F₃O₄. The iron halide may be any of FeF₂, FeF₃, FeF₂ hydrate, FeF₃ hydrate, FeCl₂, FeCl₃, FeCl₂ hydrate, FeCl₃ hydrate FeBr₂, FeBr₃, FeBr₂ hydrate, FeBr₃ hydrate, FeI₂, FeI₃, FeI₂ hydrate, FeI₃ hydrate. An intimate mixture of the iron oxide, iron halide and water is annealed at a temperature of 100° C. to ° C. for 1 second to 1000 hours. A single phase is preferred, but a multiple phase is also acceptable. The synthesized Fe₍₁₋ₐ₎MₐO_{(1-z)}Y_{z}X may be rinsed with water, or an acid such as HCl or organic solvent. The solvent may be removed by heating.

M may be considered a dopant of the composite material may be a cation of any of, or one or more of H, Mg, Ca, Al, Ga In, Se, Y, La, Ti, Zr, Hf, V, Nb, Ta, Cr, Mo and W. Sources of these dopants include halide salts or oxide forms.

Y may also be considered a dopant of the composite material and may be sourced from elemental forms thereof or as iron salts thereof.

The integer “a” may be a value from 0 to 0.75, preferably 0 to 0.5 and most preferably from 0 to 0.33. In one preferred embodiment “a” is 0.

The integer “z” may be a value from 0 to 0.75, preferably 0 to 0.5 and most preferably from 0 to 0.33. In one preferred embodiment “z” is 0.

Iron oxychloride may be a preferred form of Fe₍₁₋ₐ₎MₐO_{(1-z)}Y_{z}X and is obtained as violet opaque crystals having a layered structure which exfoliates to smaller layered particles upon mechanical treatment such as sonification. Iron oxychloride is known as a Fenton catalyst for the oxidative degradation of environmentally persistent organic materials and may be useful for applications such as wastewater treatment and soil remediation. Further, iron oxychloride has been described as a cathode active material for a chloride ion battery.

However, the inventors are aware of no prior description or use of iron oxyhalides of the formula Fe₍₁₋ₐ₎MₐO_{(1-z)}Y_{z}X, specifically iron oxychloride in combination with a metal salt as a metal ion conductive material.

Without being limited by theory, it is believed that the iron of the Fe₍₁₋ₐ₎MₐO_{(1-z)}Y_{z}X binds with the anion of the metal salt, which is the conductive ion source, thus freeing the metal ion for migration through the conductive channels of the composite of the intimate mixture of the Fe₍₁₋ₐ₎MₐO_{(1-z)}Y_{z}X exfoliate particles and metal ion salt, thus promoting high metal ion conductivity. For this reason, the Fe₍₁₋ₐ₎MₐO_{(1-z)}Y_{z}X may be considered a catalyst promoting metal ion conductivity and may be referenced as “catalyst” throughout the present disclosure.

Although any anion which effectively bonds with the Fe may be employed, the anions F⁻, Cl⁻, Br⁻, I⁻, ClO₄⁻, BF₆⁻ and PF₆⁻ are preferred and Cl⁻ is most preferred.

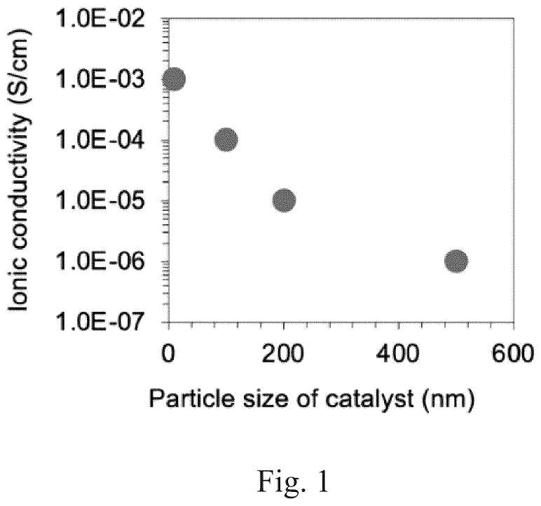

In addition, according to the present disclosure, the inventors have determined that by control of the catalyst particle size to 500 nm or less the conductivity may be significantly increased. For particle size of 500 nm or less the relationship of conductivity and metal ion particle size approaches an inverse linear curve as shown in FIG. 1. Thus, in preferred embodiments the Fe₍₁₋ₐ₎MₐO_{(1-z)}Y_{z}X particle size may be from 1 nm or less to 200 nm and in a most preferred embodiment the Fe₍₁₋ₐ₎MₐO_{(1-z)}Y_{z}X particle size may be from 10 nm or less to 100 nm.

Particle size may be determined by conventional methods including laser diffraction, dynamic light scattering, and direct imaging techniques as recognized and practiced by one of skill in the art.

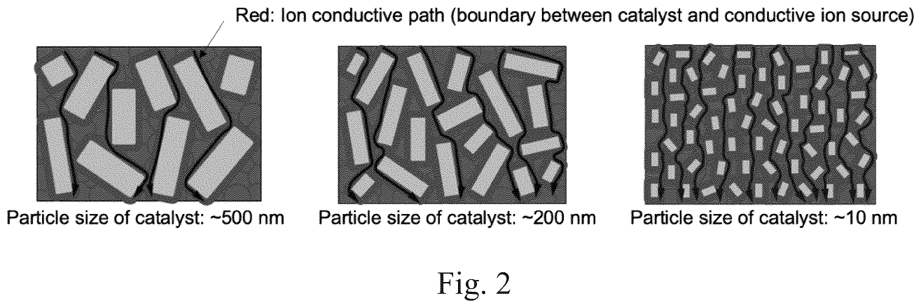

As schematically shown in FIG. 2 as the particle size of the catalyst (Fe₍₁₋ₐ₎MₐO_{(1-z)}Y_{z}X) decreases the metal ion conduction pathways increase in relative volume, thus enhancing the ionic conductivity as shown in FIG. 1. FIG. 2 also illustrates the intimate mixture of the catalyst and metal salt. The rectangular catalyst (Fe₍₁₋ₐ₎MₐO_{(1-z)}Y_{z}X) particles are intermixed with the metal salt (conductive ion source) indicated by the background of the FIG. The metal ion conduction pathways are formed at the boundaries of the particles.

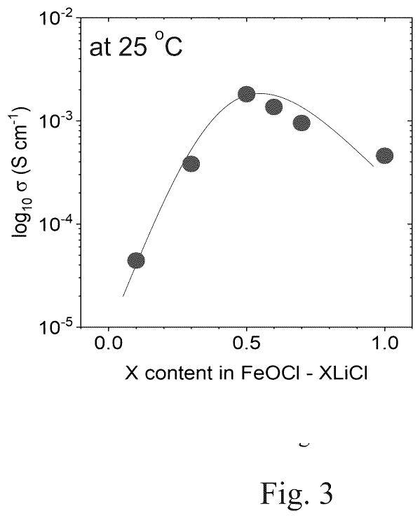

Moreover, the inventors have discovered that the metal ion conductivity of the electrolyte composite is dependent upon the relative mole ratio of the metal salt to the Fe₍₁₋ₐ₎Mₐ O_{(1-z)}Y_{z}X. Thus, as shown in FIG. 3 for the composite of formula FeOCl—XLiCl, exemplary of composites of the present disclosure, there is an optimum mole ratio between a 1/10 (0.1) and 1/1 (1.0) mole content ratio of LiCl and FeOCl, preferably, 2/10 (0.2) to 8/10 (0.8) and most preferably, 4/10 (0.4) to 7/10 (0.7).

The Fe₍₁₋ₐ₎MₐO_{(1-z)}Y_{z}X/metal salt composite material is surprisingly elastic and exhibits a relatively low Young's modulus which allows preparation of electrolyte layers of high density with low application pressure, thus facilitating battery manufacture. The Young's modulus of the composite of this disclosure may be in the range of from 1 to 18 GPa, preferably from 1 to 14 GPa and most preferably from 1 to 10 GPa. This elasticity compares favorably with conventional lithium-ion conductive sulfide solid electrolytes which generally have a Young's modulus in a range of about 24 to about 40 GPa.

The Fe₍₁₋ₐ₎MₐO_{(1-z)}Y_{z}X/metal salt composition of the present disclosure may be employed as a solid-state electrolyte for a metal ion battery, as a conductivity enhancing component of an electrode active material layer, as a coating layer on the electrode active material or any combination thereof.

Although the metal ion conductive composition may be applied as the exclusive component of a solid-state metal ion battery separator, it is also possible to provide electrolyte separators containing a mixture of the disclosed metal ion conductive composition and a ceramic ion conductive material and/or a polymer electrolyte. Such combination may be designed to meet specific battery requirements for mechanical strength, ion conductivity and other criteria.

Any ceramic electrolyte conventionally known as a metal ion conductor may be employed, depending on the identity of the metal ion battery constructed. Typical ceramic materials may include, but are not limited to, a r-LiPO₄ oxy salt, a NASCION phosphate, a perovskite oxide and a garnet oxide. These ceramic electrolytes and variations thereof are known to one of skill in the art and any ceramic electrolyte conductive to alkali metal ions, alkaline-earth metal ions, zinc ion and aluminum ion may be employed as described in the present disclosure.

When a solid-state electrolyte containing the metal ion conductive composition and a ceramic electrolyte is employed the content of the metal ion conductive composition is 30% by volume or greater to provide an electrolyte composition having workable ductility and high metal ion conductivity. Ceramic materials have a much higher Young's modulus than the metal ion conductive composition and when the content of the metal ion conductive composition is less than 30 vol %, the working properties of the composition may deteriorate. Preferably the content of the metal ion conductive composition is from 40 vol % to 98 vol % and most preferably the content of the metal ion conductive composition is from 50 vol % to 95 vol % of the total electrolyte composition.

Polymer electrolytes which may be combined with the metal ion conductive composition may include any polymer conventionally employed as a polymer electrolyte. Such polymers include, but are not limited to, a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS). Mixtures of these may be employed.

When a solid-state electrolyte containing the metal ion conductive composition and a polymer electrolyte is employed the content of the metal ion conductive composition is 1% by volume or greater to provide an electrolyte composition having workable ductility and high metal ion conductivity. Polymeric materials have a low Young's modulus and therefore, an electrolyte having high metal ion conductivity and good working properties may be prepared. Preferably the content of the metal ion conductive composition is from 10 vol % to 98 vol % and most preferably the content of the metal ion conductive composition is from 20 vol % to 95 vol % of the total electrolyte composition.

Moreover, solid-state electrolyte composition containing the metal ion conductive composition, one or more ceramic electrolytes and one or more polymer electrolytes may be prepared and employed.

Fe₍₁₋ₐ₎MₐO_{(1-z)}Y_{z}X of the target particle size may be prepared by dispersing the dry Fe₍₁₋ₐ₎MₐO_{(1-z)}Y_{z}X in acetone or a mixture of acetone and another solvent such as methyl ethyl ketone, methanol, ethanol, propanol and isopropanol, followed by sonication of the mixture until the target exfoliate particle size is obtained. The solvent may then be removed, or the mixture be employed to prepare the intimate mixture with the metal salt as described in the following paragraphs.

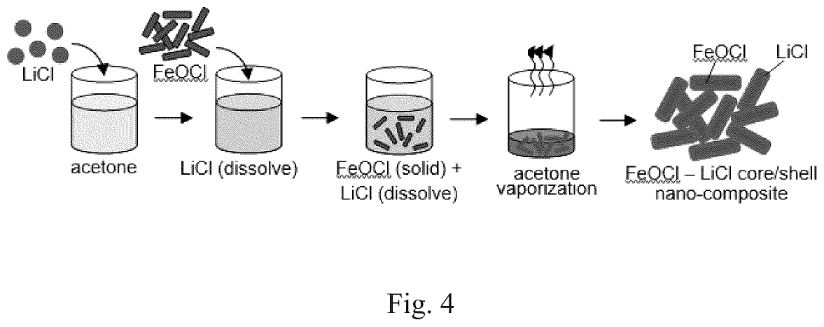

The method to prepare the intimate mixture of the Fe₍₁₋ₐ₎MₐO_{(1-z)}Y_{z}X and metal ion salt is not limited and any method to prepare the mixture having the disclosed properties may be employed. Three exemplary methods are described here and schematically shown in FIGS. 4-6 for a composite of LiCl and FeOCl. The same methods may be generally applied to other combinations of metal ion salts and Fe₍₁₋ₐ₎MₐO_{(1-z)}Y_{z}X.

### (i) Liquid Phase Method (FIG. 4)

The lithium salt (LiCl) is dissolved in a solvent or solvent mixture selected from water, acetone, methyl ethyl ketone, an alcohol such as methanol, ethanol, n-propanol or isopropyl alcohol or an aromatic solvent such as benzene or toluene. It is preferable that the lithium salt is completely dissolved in the solvent, but some may remain undissolved. The FeOCl of target particle size is added to the solvent mixture and dispersed by shaking, ultrasonication, or other treatments to promote dispersion of FeOX in the solvent. Then the solvent is evaporated to obtain the composite intimate mixture wherein the lithium salt is deposited as a shell coating on the surface of FeOCl.

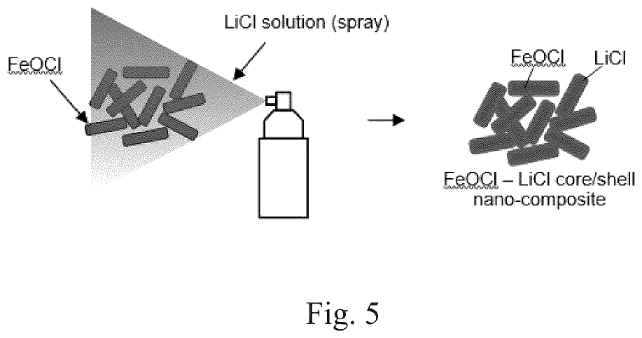

### (ii) Spray Method (FIG. 5)

The lithium salt (LiCl) is dissolved in a solvent or solvent mixture selected from water, acetone, methyl ethyl ketone, an alcohol such as methanol, ethanol, n-propanol or isopropyl alcohol or an aromatic solvent such as benzene or toluene. It is preferable that the lithium salt is completely dissolved in the solvent, but some may remain undissolved. The obtained solvent mixture is then sprayed onto the FeOCl particles of target particle size. Then the solvent is evaporated to obtain the composite intimate mixture wherein the lithium salt is deposited as a shell coating on the surface of FeOCl.

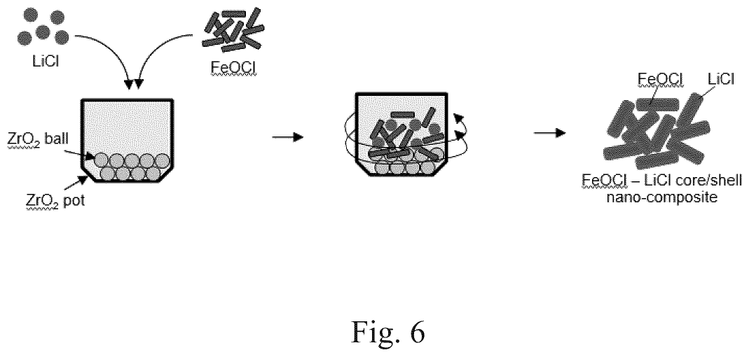

(iii) Mechanochemical Method (FIG. 6)

The lithium salt (LiCl) and FeOCl of target particle size are charged to ceramic or metal pot and milled with ceramic or metal balls by rotation of the pot at the range of 1 rpm to 5000 rpm. Due this mechanochemical treatment the lithium salt is coated on the surface of FeOX. The obtained powder may be heat-treated in the temperature range from room temperature to 400° C.

It has been determined that residual amounts of the solvent may be present in the resulting metal ion conductive composition without impairing the performance. Thus, the metal ion conductive composition may contain up to 15 wt % of residual solvent selected from the group consisting of acetone, methyl ethyl ketone, methanol, ethanol, n-propanol and isopropanol. This may also include residual contaminant water from the solvents.

The present disclosure also provides a solid-state metal ion battery, comprising:
an anode comprising an anode active material capable of insertion and extraction of at least one of an alkali metal ion, an alkaline earth metal ion, Zn ion and Al ion;
a cathode comprising a cathode active material capable of insertion and extraction of the at least one of an alkali metal ion, an alkaline earth metal ion, Zn ion and Al ion; and
a solid-state electrolyte between the anode and cathode which is conductive of at least one of an alkali metal ion, an alkaline earth metal ion, Zn ion and Al ion; wherein
at least one of the anode active material, cathode active material and solid-state electrolyte comprises the metal ion conductive composition disclosed in the previous description.

The anode active material may comprise at least one selected from the group consisting of an alkali metal, an alloy of an alkali metal, an alkaline earth metal, an alloy of an alkaline earth metal, zinc metal, a zinc alloy, aluminum metal, an aluminum alloy, graphite, hard carbon, lithium titanate (LTO), a tin/cobalt alloy, silicon, indium, bismuth and a silicon/carbon composite.

When the anode active material contains the metal ion conductive composition, the content of the metal ion conductive composition may be from 0.1% to 50% by volume. The anode may be prepared by dispersing the active material and the metal ion conductive composition in an appropriate solvent and applying the dispersed mixture onto a current collector. The solvent may be removed by drying and the material densified under pressure according to methods conventionally known. Other additives such as binders and conductive agents may also be included in the active material composition. Standard current collector materials include but are not limited to aluminum, copper, nickel, stainless steel, carbon, carbon paper and carbon cloth.

Alternatively, the metal ion conductive composition may be applied to the surface of the anode active material as a covering layer to be interposed between the active material layer and the electrolyte separator.

The cathode active material may comprise at least one selected from the group consisting of LiCoO₂, V₂O₅, CoSiO₄, MoO₃, CoSiO₄, sulfur, Mo₆S, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

When the cathode active material contains the metal ion conductive composition, the content of the metal ion conductive composition may be from 0.1% to 50% by volume. The cathode may be prepared by dispersing the active material and the metal ion conductive composition in an appropriate solvent and applying the dispersed mixture onto a current collector. The solvent may be removed by drying and the material densified under pressure according to methods conventionally known. Other additives such as binders and conductive agents may also be included in the active material composition. Standard current collector materials include but are not limited to aluminum, copper, nickel, stainless steel, carbon, carbon paper and carbon cloth.

Alternatively, the metal ion conductive composition may be applied to the surface of the cathode active material as a covering layer to be interposed between the active material layer and the electrolyte separator.

The solid-state electrolyte may be constructed of only the metal ion conductive composition and thus, the solid electrolyte may consist of the metal ion conductive composition.

Alternatively, the solid-state electrolyte may contain the metal ion conductive composition and at least one of a ceramic electrolyte and a polymer electrolyte.

As previously disclosed, any ceramic electrolyte conventionally known as a metal ion conductor may be employed, depending on the identity of the metal ion battery constructed.

Typical ceramic materials may include, but are not limited to, a T-LiPO₄ oxy salt, a NASCION phosphate, a perovskite oxide and a garnet oxide. These ceramic electrolytes and variations thereof are known to one of skill in the art and any ceramic electrolyte conductive to alkali metal ions, alkaline-earth metal ions, zinc ion and aluminum ion may be employed as described in the present disclosure.

When a solid-state electrolyte containing the metal ion conductive composition and a ceramic electrolyte is employed the content of the metal ion conductive composition is 30% by volume or greater to provide an electrolyte composition having workable ductility and high metal ion conductivity. Ceramic materials have a much higher Young's modulus than the metal ion conductive composition and when the content of the metal ion conductive composition is less than 30 vol %, the working properties of the composition may deteriorate. Preferably the content of the metal ion conductive composition is from 40 vol % to 98 vol % and most preferably the content of the metal ion conductive composition is from 50 vol % to 95 vol % of the total electrolyte composition.

Polymer electrolytes which may be combined with the metal ion conductive composition may include any polymer conventionally employed as a polymer electrolyte. Such polymers include, but are not limited to, a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS). Mixtures of these may be employed.

When a solid-state electrolyte containing the metal ion conductive composition and a polymer electrolyte is employed the content of the metal ion conductive composition is 1% by volume or greater to provide an electrolyte composition having workable ductility and high metal ion conductivity. Polymeric materials have a low Young's modulus and therefore, an electrolyte having high metal ion conductivity and good working properties may be prepared. Preferably the content of the metal ion conductive composition is from 10 vol % to 98 vol % and most preferably the content of the metal ion conductive composition is from 20 vol % to 95 vol % of the total electrolyte composition.

Moreover, solid-state electrolyte composition containing the metal ion conductive composition, one or more ceramic electrolytes and one or more polymer electrolytes may be prepared and employed.

In one preferred embodiment the present disclosure provides a solid-state lithium-ion battery, comprising:
an anode active material capable of insertion and extraction of Li⁺ ions;
a cathode active material capable of insertion and extraction of Li⁺ ions; and
a solid-state electrolyte between the anode and cathode which is conductive of Li⁺ ions;
wherein at least one of the anode active material, cathode active material and solid-state electrolyte comprises the metal ion conductive composition described above, and wherein the metal ion salt is a lithium salt selected from the group consisting of LiF, LiCl, LiBr, LiI, LiClO₄, LiBF₆ and LiPF₆.

The catalyst portion of the composite material for the solid-state lithium-ion battery may be FeOCl and specifically, a FeOCl/LiCl composite as described above.

The anode active material may comprise at least one selected from the group consisting of lithium metal, a lithium alloy graphite, hard carbon, lithium titanate (LTO), a tin/cobalt alloy, silicon, indium, bismuth and a silicon/carbon composite.

When the anode active material contains the metal ion conductive composition, the content of the metal ion conductive composition may be from 0.1% to 50% by volume. The anode may be prepared by dispersing the active material and the metal ion conductive composition in an appropriate solvent and applying the dispersed mixture onto a current collector. The solvent may be removed by drying and the material densified under pressure according to methods conventionally known. Other additives such as binders and conductive agents may also be included in the active material composition. Standard current collector materials include but are not limited to aluminum, copper, nickel, stainless steel, carbon, carbon paper and carbon cloth.

Alternatively, the metal ion conductive composition may be applied to the surface of the anode active material as a covering layer to be interposed between the active material layer and the electrolyte separator.

The cathode active material may comprise an active material selected from the group consisting of lithium cobalt oxide (LiCoO₂), lithium manganese oxide (LiMn₂O₄), lithium iron phosphate (LiFePO₄), lithium nickel manganese cobalt oxide (NMC), elemental sulfur and a metal sulfide composite.

When the cathode active material contains the metal ion conductive composition, the content of the metal ion conductive composition may be from 0.1% to 50% by volume. The cathode may be prepared by dispersing the active material and the metal ion conductive composition in an appropriate solvent and applying the dispersed mixture onto a current collector. The solvent may be removed by drying and the material densified under pressure according to methods conventionally known. Other additives such as binders and conductive agents may also be included in the active material composition. Standard current collector materials include but are not limited to aluminum, copper, nickel, stainless steel, carbon, carbon paper and carbon cloth.

Alternatively, the metal ion conductive composition may be applied to the surface of the cathode active material as a covering layer to be interposed between the active material layer and the electrolyte separator.

The solid-state electrolyte may be constructed of only the metal ion conductive composition and thus, the solid electrolyte may consist of the metal ion conductive composition.

Alternatively, the solid-state electrolyte may contain the metal ion conductive composition and at least one of a ceramic electrolyte and a polymer electrolyte.

Any ceramic electrolyte conventionally known as a lithium-ion conductor may be employed. Typical ceramic materials may include, but are not limited to, T-LiPO₄ oxy salt, Li_{3.3}PO_{3.9}N_{0.17} (LiPON), Li₁₀GeP₂S₁₂ (LGPS), Li_{9.54}Si_{1.74}P_{1.44}Si_{11.7}Cl_{0.3}, Li₇La₃Zr₂O₁₂ (LLZO), halide doped lithium thiophosphates (Li₆PS₅X, X being Cl, Br or I), Li₁₀SnP₂S₁₂ (LSPS), NASCION phosphate, a perovskite oxide and a garnet oxide.

These ceramic electrolytes and variations thereof are known to one of skill in the art and any ceramic electrolyte conductive to lithium ions may be employed as described in the present disclosure.

When a solid-state electrolyte containing the metal ion conductive composition and a ceramic electrolyte is employed the content of the metal ion conductive composition is 30% by volume or greater to provide an electrolyte composition having workable ductility and high metal ion conductivity. Ceramic materials have a much higher Young's modulus than the metal ion conductive composition and when the content of the metal ion conductive composition is less than 30 vol %, the working properties of the composition may deteriorate. Preferably the content of the metal ion conductive composition is from 40 vol % to 98 vol % and most preferably the content of the metal ion conductive composition is from 50 vol % to 95 vol % of the total electrolyte composition.

Polymer electrolytes which may be combined with the metal ion conductive composition may include any polymer conventionally employed as a polymer electrolyte. Such polymers include, but are not limited to, a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS). Mixtures of these may be employed.

When a solid-state electrolyte containing the metal ion conductive composition and a polymer electrolyte is employed the content of the metal ion conductive composition is 1% by volume or greater to provide an electrolyte composition having workable ductility and high metal ion conductivity. Polymeric materials have a low Young's modulus and therefore, an electrolyte having high metal ion conductivity and good working properties may be prepared. Preferably the content of the metal ion conductive composition is from 10 vol % to 98 vol % and most preferably the content of the metal ion conductive composition is from 20 vol % to 95 vol % of the total electrolyte composition.

Moreover, solid-state electrolyte composition containing the metal ion conductive composition, one or more ceramic electrolytes and one or more polymer electrolytes may be prepared and employed.

The above description is presented to enable a person skilled in the art to make and use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

1. A metal ion conductive composition, comprising:
an intimate mixture of at least one metal ion salt; and
a plurality of particles of formula Fe₍₁₋ₐ₎MₐO_{(1-z)}Y_{z}X;
wherein
M is a cation,
Y is an anion selected from the group consisting of N, S and Se,
X is at least one halide selected from the group consisting of F, Cl, Br and I,
a is a number from 0 to 0.75,
z is a number from 0 to 0.75,
the metal ion is selected from the group consisting of an alkali metal ion, an alkaline earth metal ion, Zn ion and Al ion, and
a particle size of the Fe₍₁₋ₐ₎MₐO_{(1-z)}Y_{z}X particles is 500 nm or less.

2. The metal ion conductive composition of claim 1, wherein an anion component of the at least one metal ion salt is selected from the group consisting of F⁻, Cl⁻, Br⁻, I⁻, ClO₄⁻, BF₆⁻ and PF₆⁻.

3. The metal ion conductive composition of claim 1, further comprising a ceramic electrolyte or a polymer electrolyte.

4. The metal ion conductive composition of claim 1, wherein a mole ratio of the metal ion salt to the Fe₍₁₋ₐ₎MₐO_{(1-z)}Y_{z}X is from 1/10 to 1/1.

5. The metal ion conductive composition of claim 3, comprising a ceramic electrolyte which is at least one ceramic electrolyte selected from the group consisting of a x-LiPO₄ oxy salt, a NASCION phosphate, a perovskite oxide and a garnet oxide.

6. The metal ion conductive composition of claim 5, wherein a content of the intimate mixture of a metal ion salt and a plurality of particles of Fe₍₁₋ₐ₎MₐO_{(1-z)}Y_{z}X is 30% by volume or more of the metal ion conductive composition.

7. The metal ion conductive composition of claim 3, comprising a polymer electrolyte which is at least one selected from the group consisting of a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS).

8. The metal ion conductive composition of claim 7, wherein a content of the intimate mixture of a metal ion salt and a plurality of particles of Fe₍₁₋ₐ₎MₐO_{(1-z)}Y_{z}X is 1% by volume or more of the metal ion conductive composition.

9. The metal ion conductive composition of claim 1, further comprising up to 15 wt % of a solvent selected from the group consisting of acetone, methanol, ethanol, propanol, isopropanol, methyl ethyl ketone and water.

10. The metal ion conductive composition of claim 1, wherein M is selected from the group consisting of H, Mg, Ca, Al, Ga In, Se, Y, La, Ti, Zr, Hf, V, Nb, Ta, Cr, Mo and W.

11. The composition of claim 1, wherein a is 0.

12. The composition of claim 1 wherein z is 0.

13. The composition of claim 1, wherein a is 0 and z is 0.

14. The composition of claim 1, wherein a is 0, z is 0 and X is Cl.

15. A solid-state metal ion battery, comprising:
an anode comprising an anode active material capable of insertion and extraction of at least one of an alkali metal ion, an alkaline earth metal ion, Zn ion and Al ion;
a cathode comprising a cathode active material capable of insertion and extraction of the at least one of an alkali metal ion, an alkaline earth metal ion, Zn ion and Al ion; and
a solid-state electrolyte between the anode and cathode which is conductive of the at least one of an alkali metal ion, an alkaline earth metal ion, Zn ion and Al ion;
wherein
at least one of the anode active material, cathode active material and solid-state electrolyte comprises the composition of claim 1.

16. The solid-state metal ion battery of claim 15, wherein the anode active material comprises at least one selected from the group consisting of an alkali metal, an alloy of an alkali metal, an alkaline earth metal, an alloy of an alkaline earth metal, zinc metal, a zinc alloy, aluminum metal, an aluminum alloy, graphite, hard carbon, lithium titanate (LTO), a tin/cobalt alloy, silicon, indium, bismuth and a silicon/carbon composite.

17. The solid-state metal ion battery of claim 15, wherein the cathode active material comprises at least one selected from the group consisting of LiCoO₂, V₂O₅, CoSiO₄, MoO₃, CoSiO₄, sulfur, Mo₆S, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

18. The solid-state metal ion battery of claim 15, wherein the solid-state electrolyte comprises the intimate mixture of at least one metal ion salt; and a plurality of particles of Fe₍₁₋ₐ₎MₐO_{(1-z)}Y_{z}X.

19. The solid-state metal ion battery of claim 15, wherein the solid-state electrolyte consists of the intimate mixture of at least one metal ion salt; and a plurality of particles of Fe₍₁₋ₐ₎MₐO_{(1-z)}Y_{z}X.

20. The solid-state metal ion battery of claim 18, wherein the solid-state electrolyte further comprises at least one of a ceramic electrolyte or a polymer electrolyte.

21. The solid-state metal ion battery of claim 18, wherein a mole ratio of the at least one metal ion salt to the Fe₍₁₋ₐ₎MₐO_{(1-z)}Y_{z}X is from 1/10 to 1/1.

22. The solid-state metal ion battery of claim 20, wherein the solid-state electrolyte comprises a ceramic electrolyte which is at least one ceramic electrolyte selected from the group consisting of a x-LiPO₄ oxy salt, a NASCION phosphate, a perovskite oxide and a garnet oxide.

23. The solid-state metal ion battery of claim 22, wherein a content of the intimate mixture of at least one metal ion salt and a plurality of particles of Fe₍₁₋ₐ₎MₐO_{(1-z)}Y_{z}X is 30% by volume or more of the solid-state electrolyte.

24. The solid state metal ion battery of claim 20, wherein the solid state electrolyte comprises a polymer electrolyte which is at least one selected from the group consisting of a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS).

25. The solid-state metal ion battery of claim 24, wherein a content of the intimate mixture of at least one metal ion salt and a plurality of particles of Fe₍₁₋ₐ₎MₐO_{(1-z)}Y_{z}X is 1% by volume or more of the solid-state electrolyte.

26. The solid-state metal ion battery of claim 15, wherein the anode active material comprises the intimate mixture of at least one metal ion salt and a plurality of particles of Fe₍₁₋ₐ₎MₐO_{(1-z)}Y_{z}X and a content of the intimate mixture is from 0.1% to 50% by volume.

27. The solid-state metal ion battery of claim 26, wherein the anode active material further comprises a conductive additive selected from a conductive carbon, Fe particles and Ti particles.

28. The solid-state metal ion battery of claim 15, wherein the cathode active material comprises the intimate mixture of at least one metal ion salt; and a plurality of particles of Fe₍₁₋ₐ₎MₐO_{(1-z)}Y_{z}X and a content of the intimate mixture is from 0.1% to 50% by volume.

29. The solid-state metal ion battery of claim 28, wherein the cathode active material further comprises a conductive additive selected from a conductive carbon, Fe particles and Ti particles.

30. The solid-state metal ion battery of claim 15, wherein the plurality of particles is FeOCl.

31. A solid-state lithium-ion battery, comprising:
an anode active material capable of insertion and extraction of Li⁺ ions;
a cathode active material capable of insertion and extraction of Li⁺ ions; and
a solid-state electrolyte between the anode and cathode which is conductive of Li⁺ ions;
wherein
at least one of the anode active material, cathode active material and solid-state electrolyte comprises the composition of claim 1,
wherein the at least one metal ion salt comprises a lithium salt selected from the group consisting of LiCl, LiClO₄, LiBF₆ and LiPF₆.

32. The solid-state lithium-ion battery of claim 31, wherein the anode active material comprises at least one selected from the group consisting of lithium metal, a lithium alloy graphite, hard carbon, lithium titanate (LTO), a tin/cobalt alloy, silicon, indium, bismuth and a silicon/carbon composite.

33. The solid-state lithium-ion battery of claim 31, wherein the cathode active material comprises an active material selected from the group consisting of lithium cobalt oxide (LiCoO₂), lithium manganese oxide (LiMn₂O₄), lithium iron phosphate (LiFePO₄), lithium nickel manganese cobalt oxide (NMC), elemental sulfur and a metal sulfide composite.

34. The solid-state lithium-ion battery of claim 31, wherein a mole ratio of the lithium salt to the Fe₍₁₋ₐ₎MₐO_{(1-z)}Y_{z}X is from 1/10 to 1/1.

35. The solid-state lithium-ion battery of claim 31, wherein the solid-state electrolyte consists of the intimate mixture comprising a lithium-ion salt and a plurality of particles of Fe₍₁₋ₐ₎MₐO_{(1-z)}Y_{z}X.

36. The solid-state lithium-ion battery of claim 31, wherein the solid-state electrolyte comprises the intimate mixture comprising a lithium-ion salt and a plurality of particles of Fe₍₁₋ₐ₎MₐO_{(1-z)}Y_{z}X.

37. The solid-state metal ion battery of claim 36, wherein the solid-state electrolyte further comprises at least one of a ceramic electrolyte or a polymer electrolyte.

38. The solid state lithium ion battery of claim 37, wherein the solid state electrolyte further comprises at least one of a ceramic material selected from the group consisting of r-LiPO₄ oxy salt, Li_{3.3}PO_{3.9}N_{0.17} (LiPON), Li₁₀GeP₂S₁₂ (LGPS), Li_{9.54}Si_{1.74}P_{1.44}Si_{11.7}Cl_{0.3}, Li₇La₃Zr₂O₁₂ (LLZO), halide doped lithium thiophosphates (Li₆PS₅X, X being Cl, Br or I), Li₁₀SnP₂S₁₂ (LSPS), NASCION phosphate, a perovskite oxide and a garnet oxide.

39. The solid-state lithium-ion battery of claim 37, wherein a content of the intimate mixture comprising a lithium-ion salt and a plurality of particles of Fe₍₁₋ₐ₎MₐO_{(1-z)}Y_{z}X is 30% by volume or more of the solid-state electrolyte.

40. The solid-state lithium-ion battery of claim 37, wherein the solid-state electrolyte further comprises a polymer which is at least one selected from the group consisting of a poly(ethylene oxide), a polycaprolactone, a polylactic acid, a polysiloxane, a polyacrylonitrile, a polyvinylidene fluoride and a poly(methyl methacrylate), a polypyrrole, a polyaniline, a polythiophene, a poly(3,4-ethylenedioxythiophene) (PEDOT) and a poly(ethylene dioxythiophene):poly(styrenesulfonate) (PEDOT:PSS).

41. The solid-state lithium-ion battery of claim 40, wherein a content of the intimate mixture comprising a lithium-ion salt and a plurality of particles of Fe₍₁₋ₐ₎MₐO_{(1-z)}Y_{z}X is 1% by volume or more of the solid-state electrolyte.

42. The solid-state lithium-ion battery of claim 31, wherein the anode active material comprises the intimate mixture comprising a lithium-ion salt and a plurality of particles of Fe₍₁₋ₐ₎MₐO_{(1-z)}Y_{z}X and a content of the intimate mixture is from 0.1% to 50% by volume.

43. The solid-state lithium-ion battery of claim 42, wherein the anode active material further comprises a conductive additive selected from a conductive carbon, Fe particles and Ti particles.

44. The solid-state lithium-ion battery of claim 31, wherein the cathode active material comprises the intimate mixture comprising a lithium-ion salt and a plurality of particles of Fe₍₁₋ₐ₎MₐO_{(1-z)}Y_{z}X and a content of the intimate mixture is from 0.1% to 50% by volume.

45. The solid-state metal ion battery of claim 44, wherein the cathode active material further comprises a conductive additive selected from a conductive carbon, Fe particles and Ti particles.

46. The solid-state lithium-ion battery of claim 31, wherein the plurality of particles is FeOCl.

47. The solid-state lithium-ion battery of claim 31, wherein the intimate mixture comprising a lithium-ion salt; and a plurality of particles of Fe₍₁₋ₐ₎MₐO_{(1-z)}Y_{z}X further comprises up to 15 wt % of a solvent selected from the group consisting of acetone, methanol, ethanol, propanol, methyl ethyl ketone and water.
